(19) United States
(12) Patent Application Publication
(10) Pub. No.: US 2023/0052742 A1
(43) Pub. Date: Feb. 16, 2023

(54) FLUIDIC OSCILLATOR DEVICE WITH THREE-DIMENSIONAL OUTPUT

(71) Applicant: Ohio State Innovation Foundation, Columbus, OH (US)

(72) Inventor: Mehmet TOMAC, Worthington, OH (US)

(21) Appl. No.: 17/792,129

(22) PCT Filed: Feb. 7, 2020
(86) PCT No.: PCT/US2020/017249

§ 371 Date: Jul. 11, 2022

Related U.S. Application Data
(60) Provisional application No. 62/960,343, filed on Jan. 13, 2020.

(51) Int. Cl. B05B 1/08; B05B 1/26

(52) U.S. Cl. CPC B05B 1/08; B05B 1/26

(57) ABSTRACT

Various implementations include fluidic oscillator devices with three-dimensional output. The devices define an inner channel having an interaction chamber, fluid supply inlet, outlet nozzle, and first and second feedback channels. The fluid supply inlet introduces a fluid stream into the interaction chamber. The fluid stream exits the interaction chamber through the outlet nozzle. The first and second feedback channels are in fluid communication with the interaction chamber. The walls of the interaction chamber are configured to allow fluid from the fluid stream to flow into the first and second feedback channels and to cause the fluid stream to sweep between the walls of the interaction chamber. The sweeping of the fluid stream between the wails of the interaction chamber causes the fluid stream exiting the outlet nozzle to sweep. The structure of the inner channel of the device causes the exiting fluid stream to sweep three-dimensionally.

### CROSS-REFERENCE TO RELATED APPLICATIONS

This application claims the benefit of U.S. Provisional Pat. Application No. 62/960,343, filed Jan. 13, 2020, the content of which is incorporated herein by reference in its entirety.

### BACKGROUND

Fluidic oscillators are a type of non-moving part, fluidic device that produce a pulsed or sweeping jet with a wide range of frequencies. They operate solely by employing fluid dynamic principles when supplied by a pressurized fluid. These devices are generally preferred in many engineering applications, since they can provide a wide range of frequencies, have a simple maintenance-free design without moving parts, and generate an output jet that is unsteady and spreads more than a regular jet. However, a problem with typical fluidic oscillators is that the oscillating output jet created with any fluidic oscillator is two-dimensional (“2D”) by its nature. This constricts the use of fluidic oscillators where a three-dimensional (“3D”) output jet is desired. Thus, there is a desire for a fluidic oscillator that can create an oscillating fluid stream in a 3D space.

### SUMMARY

Various implementations of the present disclosure include a feedback type fluidic oscillator device with three-dimensional output. The device includes a body having a first surface and a second surface spaced apart from the first surface. The first surface and the second surface at least partially define an inner channel. The inner channel includes an interaction chamber, a fluid supply inlet, an outlet nozzle, and first and second feedback channels.

The interaction chamber has a first attachment wall and a second attachment wall extending between the first surface and the second surface. The first attachment wall and the second attachment wall are opposite and spaced apart from each other. The fluid supply inlet is configured to introduce a fluid stream into the interaction chamber. The outlet nozzle is downstream of the fluid supply inlet. The fluid stream exits the interaction chamber through the outlet nozzle.

The first feedback channel is coupled to the first attachment wall, and the second feedback channel is coupled to the second attachment wall. The first feedback channel and second feedback channel are in fluid communication with the interaction chamber. Each of the first feedback channel and second feedback channel have a first end and a second end opposite and spaced apart from the first end. The first end is adjacent the outlet nozzle, and the second end is adjacent the fluid supply inlet. The first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber.

The sweeping of the fluid stream between the first attachment wall and second attachment wall of the interaction chamber causes the fluid stream exiting the outlet nozzle to sweep. A portion of the inner channel has a maximum thickness, as measured from between the first surface and the second surface, that is thicker than another portion of the inner channel such that the fluid stream exiting the outlet nozzle sweeps three-dimensionally.

In some implementations, a portion of the inner channel has an increasing thickness, as measured from between the first surface and the second surface, such that the portion of the inner channel with the maximum thickness is the outlet nozzle. In some implementations, the portion of the inner channel that has the increasing thickness is a tapered portion of the inner channel. In some implementations, the portion of the inner channel that has the increasing thickness is a curved portion of the inner channel.

In some implementations, a portion of the inner channel has an increasing thickness and a decreasing thickness, as measured from between the first surface and the second surface, such that the portion of the inner channel with the maximum thickness is the interaction chamber. In some implementations, the portion of the inner channel that has the increasing thickness and the decreasing thickness is a tapered portion of the inner channel. In some implementations, the portion of the inner channel that has the increasing thickness and the decreasing thickness is a curved portion of the inner channel.

In some implementations, the outlet nozzle includes one or more dividers configured to divide the fluid stream exiting the outlet nozzle into two or more exiting fluid streams. Each of the two or more exiting fluid streams sweep in a separate sweeping plane.

Various other implementations of the present disclosure include a feedback type fluidic oscillator device with three-dimensional output. The device includes a body having a first surface, a second surface spaced apart from the first surface, and a central longitudinal axis. The first surface and the second surface at least partially define an inner channel. The inner channel includes an interaction chamber, a fluid supply inlet, an outlet nozzle, and first and second feedback channels.

The interaction chamber has a first attachment wall and a second attachment wall extending between the first surface and the second surface. The first attachment wall and the second attachment wall are opposite and spaced apart from each other. The fluid supply inlet is configured to introduce a fluid stream into the interaction chamber. The outlet nozzle is downstream of the fluid supply inlet. The fluid stream exits the interaction chamber through the outlet nozzle.

The first feedback channel is coupled to the first attachment wall, and the second feedback channel is coupled to the second attachment wall. The first feedback channel and second feedback channel are in fluid communication with the interaction chamber. Each of the first feedback channel and second feedback channel have a first end and a second end opposite and spaced apart from the first end. The first end is adjacent the outlet nozzle and the second end is adjacent the fluid supply inlet. The first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber.

The sweeping of the fluid stream between the first attachment wall and second attachment wall of the interaction chamber causes the fluid stream exiting the outlet nozzle to sweep. The outlet nozzle has a cross-sectional shape in a plane perpendicular to the central longitudinal axis. The cross-sectional shape is a bent rectangle such that the fluid stream exiting the outlet nozzle sweeps three-dimensionally.

In some implementations, the bent rectangle is a curved rectangle. In some implementations, the first surface and the second surface of the inner channel have the same radius of curvature in the plane perpendicular to the central longitudinal axis.

In some implementations, the bent rectangle is a v-shaped rectangle. In some implementations, the first surface and the second surface of the inner channel are bent at a same angle in the plane perpendicular to the central longitudinal axis.

Various other implementations of the present disclosure include a feedback type fluidic oscillator device with three-dimensional output. The device includes a body having a first surface and a second surface spaced apart from the first surface. The first surface and the second surface at least partially define an inner channel. The inner channel includes an interaction chamber, a fluid supply inlet, an outlet nozzle, first and second feedback channels, and at least one secondary feedback channel.

The interaction chamber has a first attachment wall and a second attachment wall extending between the first surface and the second surface. The first attachment wall and the second attachment wall are opposite and spaced apart from each other. The fluid supply inlet is configured to introduce a fluid stream into the interaction chamber. The outlet nozzle is downstream of the fluid supply inlet. The fluid stream exits the interaction chamber through the outlet nozzle.

The first feedback channel is coupled to the first attachment wall, and the second feedback channel is coupled to the second attachment wall. The first feedback channel and second feedback channel are in fluid communication with the interaction chamber. Each of the first feedback channel and second feedback channel have a first end and a second end opposite and spaced apart from the first end. The first end is adjacent the outlet nozzle and the second end is adjacent the fluid supply inlet. The first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber.

Each of the at least one secondary feedback channels has a first end and a second end opposite and spaced apart from the first end of the secondary feedback channel. The first end of the secondary feedback channel is in fluid communication with either the interaction chamber, the first feedback channel, or the second feedback channel, and a second end of the secondary feedback channel is in fluid communication with the outlet nozzle. The first end of the secondary feedback channel is positioned to allow fluid from the fluid stream to flow into the first end of the secondary feedback channel and out of the second end of the secondary feedback channel and to interact with the fluid stream in the outlet nozzle.

The sweeping of the fluid stream between the first attachment wall and second attachment wall of the interaction chamber causes the fluid stream exiting the outlet nozzle to sweep. The fluid exiting the second end of the at least one secondary feedback channel interacts with the sweeping fluid stream exiting the outlet nozzle such that the fluid stream exiting the outlet nozzle sweeps three-dimensionally.

In some implementations, the second end of the secondary feedback channel is defined by a side wall of the outlet nozzle. The side wall extends between the first surface and second surface of the inner channel. In some implementations, the device includes a first secondary feedback channel and a second secondary feedback channel. The second end of the first secondary feedback channel is defined by a first side wall of the outlet nozzle, and the second end of the second secondary feedback channel is defined by a second side wall of the outlet nozzle. The first side wall and the second side wall are opposite and spaced apart from each other.

In some implementations, the second end of the secondary feedback channel is defined by either the first surface or second surface of the inner channel.

In some implementations, the device comprises a first secondary feedback channel and a second secondary feedback channel. The second end of the first secondary feedback channel is defined by a portion of the first surface of the inner channel defining the outlet nozzle, and the second end of the second secondary feedback channel is defined by a portion of the second surface of the inner channel defining the outlet nozzle.

Various other implementations of the present disclosure include a feedback type fluidic oscillator device with three-dimensional output. The device includes at least two fluidic oscillators. The at least two fluidic oscillators include a first fluidic oscillator and a second fluidic oscillator. Each of the first fluidic oscillator and second fluidic oscillator include a body having a first surface, a second surface spaced apart from the first surface, and a central plane located equally spaced from the first surface and the second surface. The first surface and the second surface at least partially define an inner channel. The inner channel includes an interaction chamber, a fluid supply inlet, an outlet nozzle, and first and second feedback channels.

In each of the at least two fluidic oscillators, the sweeping of the fluid stream between the first attachment wall and second attachment wall of the interaction chamber causes the fluid stream exiting the outlet nozzle to sweep. The central plane of the first fluidic oscillator is transverse to the central plane of the second fluidic oscillator. The at least two fluidic oscillators interact such that the fluid stream exiting the outlet nozzle of one of the at least two fluidic oscillators sweeps three-dimensionally.

In some implementations, each of the at least two fluidic oscillators has a central longitudinal axis, and each of the central longitudinal axes are coincident with each other. In some implementations, the first fluidic oscillator is disposed upstream from the second fluidic oscillator such that the outlet nozzle of the first inner channel is in fluid communication with the fluid supply inlet of the second inner channel.

In some implementations, the central plane of the first fluidic oscillator is perpendicular to the central plane of the second fluidic oscillator.

In some implementations, the interaction chamber of the first fluidic oscillator is directly in fluid communication with the interaction chamber of the second fluidic oscillator.

In some implementations, the device further includes a third fluidic oscillator, and the interaction chambers of the first fluidic oscillator, the second fluidic oscillator, and the third fluidic oscillator are in fluid communication with each other.

Various other implementations of the present disclosure include a feedback type fluidic oscillator device with three-dimensional output. The device includes a body having a central longitudinal axis. The body defines an inner channel. The inner channel includes an interaction chamber, a fluid supply inlet, an outlet nozzle, and three or more feedback channels.

The interaction chamber has an annular attachment wall extending circumferentially around the central longitudinal axis. The fluid supply inlet is configured to introduce a fluid stream into the interaction chamber. The outlet nozzle is downstream of the fluid supply inlet. The fluid stream exits the interaction chamber through the outlet nozzle.

The three or more feedback channels are coupled to and spaced circumferentially around the annular attachment wall. Each of the three or more feedback channels is in fluid communication with the interaction chamber. Each of the three or more feedback channels has a first end and a second end opposite and spaced apart from the first end. The first end is adjacent the outlet nozzle and the second end is adjacent the fluid supply inlet. The annular attachment wall of the interaction chamber is configured to allow fluid from the fluid stream to flow into the first end of one of the three or more feedback channels and to cause the fluid stream to sweep across the annular attachment wall of the interaction chamber.

The sweeping of the fluid stream across the annular attachment wall of the interaction chamber causes the fluid stream exiting the outlet nozzle to sweep three-dimensionally.

In some implementations, the three or more feedback channels comprise three feedback channels. In some implementations, the three or more feedback channels comprise four feedback channels. In some implementations, the three or more feedback channels comprise five feedback channels. In some implementations, the three or more feedback channels comprise six or more feedback channels.

In some implementations, the three or more feedback channels are circumferentially equally spaced apart from each other around the annular attachment wall.

Various other implementations of the present disclosure include a jet interaction type fluidic oscillator device with three-dimensional output. The device includes a body defining an inner channel. The inner channel includes an interaction chamber, a first fluid supply inlet, a second fluid supply inlet, a third fluid supply inlet, and an outlet nozzle.

The first fluid supply inlet is configured to introduce a first inlet fluid stream into the interaction chamber. The second fluid supply inlet is configured to introduce a second inlet fluid stream into the interaction chamber. The third fluid supply inlet is configured to introduce a third inlet fluid stream into the interaction chamber. The outlet nozzle is configured to discharge an outlet fluid stream from the interaction chamber through the outlet nozzle. The collision of the first inlet fluid stream, the second inlet fluid stream, and the third inlet fluid stream causes the outlet fluid stream to sweep three-dimensionally as the outlet fluid stream is discharged from the outlet nozzle.

In some implementations, the interaction chamber defines a fourth fluid supply inlet configured to introduce a fourth inlet fluid stream into the interaction chamber.

In some implementations, the interaction chamber is partially defined by a dome-shaped wall. In some implementations, the first fluid supply inlet, the second fluid supply inlet, and the third fluid supply inlet are spaced circumferentially around the dome-shaped wall.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1A is a top view of a single feedback-type fluidic oscillator of the prior art.

FIG. 1B is an end view of the single feedback-type fluidic oscillator of FIG. 1A.

FIG. 2A is a perspective view of a feedback type fluidic oscillator device with three-dimensional output, according to one implementation of the present disclosure.

FIG. 2B is a cross-sectional side view of the device of FIG. 2A along line A-A.

FIG. 2C is a cross-sectional perspective view of the device of FIG. 2A along line B-B.

FIG. 2D is a perspective view of a feedback type fluidic oscillator device with three-dimensional output, according to another implementation of the present disclosure.

FIG. 2E is a cross-sectional side view of the device of FIG. 2D along line C-C.

FIG. 2F is a cross-sectional perspective view of the device of FIG. 2D along line D-D.

FIG. 2G is a perspective view of a feedback type fluidic oscillator device with three-dimensional output, according to another implementation of the present disclosure.

FIG. 2H is a cross-sectional side view of the device of FIG. 2G along line E-E.

FIG. 2I is a cross-sectional perspective view of the device of FIG. 2G along line F-F.

FIG. 3A is a perspective view of a feedback type fluidic oscillator device with three-dimensional output, according to another implementation of the present disclosure.

FIG. 3B is a cross-sectional view of the device of FIG. 3A along line G-G.

FIG. 4A is a perspective view of a feedback type fluidic oscillator device with three-dimensional output, according to another implementation of the present disclosure.

FIG. 4B is a cross-sectional side view of the device of FIG. 4A along line H-H.

FIG. 4C is a cross-sectional perspective view of the device of FIG. 4A along line I-I.

FIG. 5A is a perspective view of a feedback type fluidic oscillator device with three-dimensional output, according to another implementation of the present disclosure.

FIG. 5B is a cross-sectional view of the device of FIG. 5A along line J-J.

FIG. 6A is a perspective view of a feedback type fluidic oscillator device with three-dimensional output, according to another implementation of the present disclosure.

FIG. 6B is a cross-sectional view of the device of FIG. 6A along line K-K.

FIG. 7A is a perspective view of a feedback type fluidic oscillator device with three-dimensional output, according to another implementation of the present disclosure.

FIG. 7B is an end view of the device of FIG. 7A.

FIG. 8A is a perspective view of a feedback type fluidic oscillator device with three-dimensional output, according to another implementation of the present disclosure.

FIG. 8B is an end view of the device of FIG. 8A.

FIG. 9A is a perspective view of a feedback type fluidic oscillator device with three-dimensional output, according to another implementation of the present disclosure.

FIG. 9B is a cross-sectional view of the device of FIG. 9A along line L-L.

FIG. 10 is a perspective view of a feedback type fluidic oscillator device with three-dimensional output, according to another implementation of the present disclosure.

FIG. 11A is a perspective view of a feedback type fluidic oscillator device with three-dimensional output, according to another implementation of the present disclosure.

FIG. 11B is a cross-sectional view of the device of FIG. 11A along line M-M.

FIG. 11C is a partial view of the device of FIG. 11A.

FIG. 12A is a perspective view of a feedback type fluidic oscillator device with three-dimensional output, according to another implementation of the present disclosure.

FIG. 12B is a cross-sectional view of the device of FIG. 12A along line N-N.

FIG. 12C is a cross-sectional view of the device of FIG. 12A along line O-O.

FIG. 13 is a perspective view of a feedback type fluidic oscillator device with three-dimensional output, according to another implementation of the present disclosure.

FIG. 14A is a perspective view of a feedback type fluidic oscillator device with three-dimensional output, according to another implementation of the present disclosure.

FIG. 14B is a cross-sectional view of the device of FIG. 14A along line P-P.

FIG. 14C is a cross-sectional view of the device of FIG. 14A along line Q-Q.

FIG. 15A is a perspective view of a feedback type fluidic oscillator device with three-dimensional output, according to another implementation of the present disclosure.

FIG. 15B is a cross-sectional side view of the device of FIG. 15A along line R-R.

FIG. 15C is a cross-sectional perspective view of the device of FIG. 15A along line R-R.

### DETAILED DESCRIPTION

The devices, systems, and methods disclosed herein provide for the production of a 3-D, sweeping output fluid stream. Current fluidic oscillator devices produce an output fluid stream that sweep in a single plane (i.e., sweeping in the x-axis as the fluid flows out of the device generally in the y-axis). The devices, systems, and methods disclosed herein include features that that interact with the fluid stream flowing through the devices to cause the output fluid stream to also spread or sweep in a third dimension perpendicular to the sweeping plane (i.e., in the z-axis).

Various implementations include a feedback type fluidic oscillator device with three-dimensional output. The device includes a body having a first surface and a second surface spaced apart from the first surface. The first surface and the second surface at least partially define an inner channel. The inner channel includes an interaction chamber, a fluid supply inlet, an outlet nozzle, and first and second feedback channels.

The interaction chamber has a first attachment wall and a second attachment wall extending between the first surface and the second surface. The first attachment wall and the second attachment wall are opposite and spaced apart from each other. The fluid supply inlet is configured to introduce a fluid stream into the interaction chamber. The outlet nozzle is downstream of the fluid supply inlet. The fluid stream exits the interaction chamber through the outlet nozzle.

The first feedback channel is coupled to the first attachment wall, and the second feedback channel is coupled to the second attachment wall. The first feedback channel and second feedback channel are in fluid communication with the interaction chamber. Each of the first feedback channel and second feedback channel have a first end and a second end opposite and spaced apart from the first end. The first end is adjacent the outlet nozzle, and the second end is adjacent the fluid supply inlet. The first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber.

The sweeping of the fluid stream between the first attachment wall and second attachment wall of the interaction chamber causes the fluid stream exiting the outlet nozzle to sweep.

In some implementations, a portion of the inner channel has a maximum thickness, as measured from between the first surface and the second surface, that is thicker than another portion of the inner channel such that the fluid stream exiting the outlet nozzle sweeps three-dimensionally.

In some implementations, the inner channel has a central longitudinal axis, and the outlet nozzle has a cross-sectional shape in a plane perpendicular to the central longitudinal axis. The cross-sectional shape is a bent rectangle such that the fluid stream exiting the outlet nozzle sweeps three-dimensionally.

In some implementations, the inner channel includes at least one secondary feedback channel. Each of the at least one secondary feedback channels has a first end and a second end opposite and spaced apart from the first end of the secondary feedback channel. The first end of the secondary feedback channel is in fluid communication with either the interaction chamber, the first feedback channel, or the second feedback channel, and a second end of the secondary feedback channel is in fluid communication with the outlet nozzle. The first end of the secondary feedback channel is positioned to allow fluid from the fluid stream to flow into the first end of the secondary feedback channel and out of the second end of the secondary feedback channel and to interact with the fluid stream in the outlet nozzle. The fluid exiting the second end of the at least one secondary feedback channel interacts with the sweeping fluid stream exiting the outlet nozzle such that the fluid stream exiting the outlet nozzle sweeps three-dimensionally.

In some implementations, the device includes at least a first fluidic oscillator and a second fluidic oscillator. Each of the first and second fluidic oscillators defines an inner channel and has a central plane located equally spaced from the first surface and the second surface. The central plane of the first fluidic oscillator is transverse to the central plane of the second fluidic oscillator. The at least two fluidic oscillators interact such that the fluid stream exiting the outlet nozzle of one of the at least two fluidic oscillators sweeps three-dimensionally.

Various other implementations include a feedback type fluidic oscillator device with three-dimensional output. The device includes a body having a central longitudinal axis. The body defines an inner channel. The inner channel includes an interaction chamber, a fluid supply inlet, an outlet nozzle, and three or more feedback channels.

The interaction chamber has an annular attachment wall extending circumferentially around the central longitudinal axis. The fluid supply inlet is configured to introduce a fluid stream into the interaction chamber. The outlet nozzle is downstream of the fluid supply inlet. The fluid stream exits the interaction chamber through the outlet nozzle.

The three or more feedback channels are coupled to and spaced circumferentially around the annular attachment wall. Each of the three or more feedback channels is in fluid communication with the interaction chamber. Each of the three or more feedback channels has a first end and a second end opposite and spaced apart from the first end. The first end is adjacent the outlet nozzle and the second end is adjacent the fluid supply inlet. The annular attachment wall of the interaction chamber is configured to allow fluid from the fluid stream to flow into the first end of one of the three or more feedback channels and to cause the fluid stream to sweep across the annular attachment wall of the interaction chamber. The sweeping of the fluid stream across the annular attachment wall of the interaction chamber causes the fluid stream exiting the outlet nozzle to sweep three-dimensionally.

Various other implementations include a jet interaction type fluidic oscillator device with three-dimensional output. The device includes a body defining an inner channel. The inner channel includes an interaction chamber, a first fluid supply inlet, a second fluid supply inlet, a third fluid supply inlet, and an outlet nozzle.

The first fluid supply inlet is configured to introduce a first inlet fluid stream into the interaction chamber. The second fluid supply inlet is configured to introduce a second inlet fluid stream into the interaction chamber. The third fluid supply inlet is configured to introduce a third inlet fluid stream into the interaction chamber. The outlet nozzle is configured to discharge an outlet fluid stream from the interaction chamber through the outlet nozzle. The collision of the first inlet fluid stream, the second inlet fluid stream, and the third inlet fluid stream causes the outlet fluid stream to sweep three-dimensionally as the outlet fluid stream is discharged from the outlet nozzle.

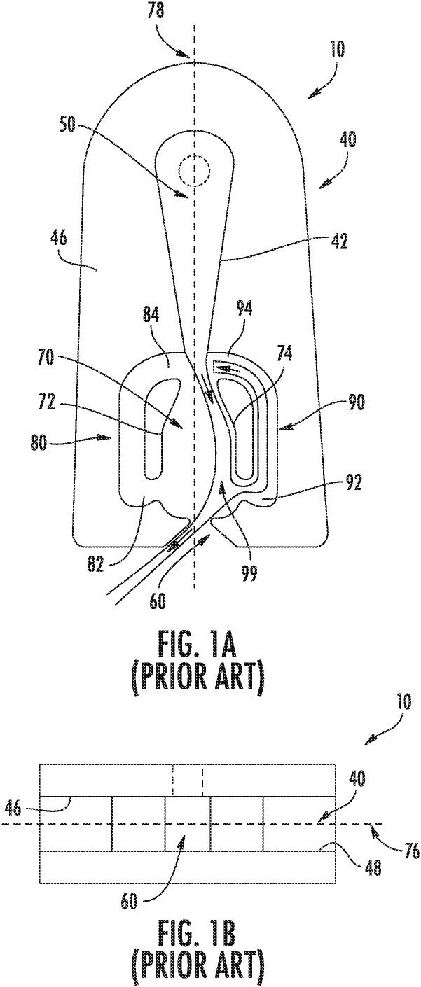

FIG. 1A shows a top view of a single fluidic oscillator 10 of the prior art, and FIG. 1B shows an end view of the single fluidic oscillator 10 as viewed from the outlet nozzle 60. The fluidic oscillator 10 includes a body 40 having a first surface 46 and a second surface 48 spaced apart from the first surface 46. The first surface 46 and the second surface 48 of the body 40 define an inner channel 42. The inner channel 42 of the body 40 includes an interaction chamber 70, a fluid supply inlet 50, an outlet nozzle 60, a first feedback channel 80, a second feedback channel 90, a central longitudinal axis 78, and a central plane 76. The central plane 76 is disposed equally distanced from the first surface 46 and the second surface 48.

The interaction chamber 70 is defined by a first attachment wall 72 and a second attachment wall 74 extending between the first surface 46 and the second surface 48. The first attachment wall 72 and the second attachment wall 74 are opposite and spaced apart from each other. The first attachment wall 72 and second attachment wall 74 mirror each other across a plane including the central longitudinal axis 78 and perpendicular to the central plane 76. Each attachment wall 72, 74 has a curvature such that the first attachment wall 72 and second attachment wall 74 are closer to each other adjacent the fluid supply inlet 50 than adjacent the outlet nozzle 60, as discussed below.

The fluid supply inlet 50 of the body 40 is in fluid communication with the interaction chamber 70. In use, a fluid stream 99 is introduced from the fluid supply inlet 50 into the interaction chamber 70.

The outlet nozzle 60 of the body 40 is in fluid communication with the interaction chamber 70 and is located downstream of the fluid supply inlet 50. The central longitudinal axis 78 extends from the fluid supply inlet 50, through the interaction chamber 70, to the exiting end of the outlet nozzle 60. In use, the fluid stream 99 exits the interaction chamber 70 through the outlet nozzle 60.

The first feedback channel 80 and the second feedback channel 90 each have a first end 82, 92 and a second end 84, 94 opposite and spaced apart from the first end 82, 92. The first feedback channel 80 is coupled to the first attachment wall 72 and the second feedback channel 90 is coupled to the second attachment wall 74 such that both the first feedback channel 80 and the second feedback channel 90 are in fluid communication with the interaction chamber 70. The first end 82, 92 of both feedback channels 80, 90 is adjacent the outlet nozzle 60 such that the first ends 82, 92 of the feedback channels 80, 90 are closer than the second ends 84, 94 of the feedback channels 80, 90 to the outlet nozzle 60. The second end 84, 94 of both feedback channels 80, 90 is adjacent the fluid supply inlet 50 such that the second ends 84, 94 of the feedback channels 80, 90 are closer than the first ends 82, 92 of the feedback channels 80, 90 to the fluid supply inlet 50.

A fluid stream 99 enters the fluidic oscillator 10 through the fluid supply inlet 50, flows through the interaction chamber 70, and eventually exits the fluidic oscillator 10 through the outlet nozzle 60. The first attachment wall 72 and second attachment wall 74 of the interaction chamber 70 are a predetermined distance from each other such that, as the fluid stream 99 flows through the interaction chamber 70, a pressure difference across the fluid stream 99 causes the fluid stream 99 to deflect toward, and eventually attach to, either the first attachment wall 72 or the second attachment wall 74 due to the Coanda effect. The first attachment wall 72 and second attachment wall 74 of the interaction chamber 70 are shaped to allow fluid from the fluid stream 99 to flow into the first ends 82, 92 of the first feedback channel 80 and second feedback channel 90, respectively, when the fluid stream 99 is attached to that attachment wall 72, 74. The fluid stream 99 can include any fluid, for example any liquid or gas.

When the fluid stream 99 is attached to the first attachment wall 72, fluid from the fluid stream 99 enters the first end 82 of the first feedback channel 80, flows through the first feedback channel 80 and out of the second end 84 of the first feedback channel 80. The fluid exiting the second end 84 of the first feedback channel 80 contacts the fluid stream 99 adjacent the fluid supply inlet 50, causing the fluid stream 99 to detach from the first attachment wall 72 and attach to the second attachment wall 74. Fluid from the fluid stream 99 then enters the first end 92 of the second feedback channel 90, flows through the second feedback channel 90 and out of the second end 94 of the second feedback channel 90. The fluid exiting the second end 94 of the second feedback channel 90 contacts the fluid stream 99 adjacent the fluid supply inlet 50, causing the fluid stream 99 to detach from the second attachment wall 74 and attach back to the first attachment wall 72. The fluid stream 99 continues to oscillate between attachment to the first attachment wall 72 and second attachment wall 74 of the interaction chamber 70.

Because of the shape of the outlet nozzle 60 and the curvature of the first attachment wall 72 and second attachment wall 74, the oscillation of the fluid stream 99 between the first attachment wall 72 and the second attachment wall 74 causes the fluid stream 99 to oscillate as the fluid stream 99 exits the fluidic oscillator 10 through the outlet nozzle 60.

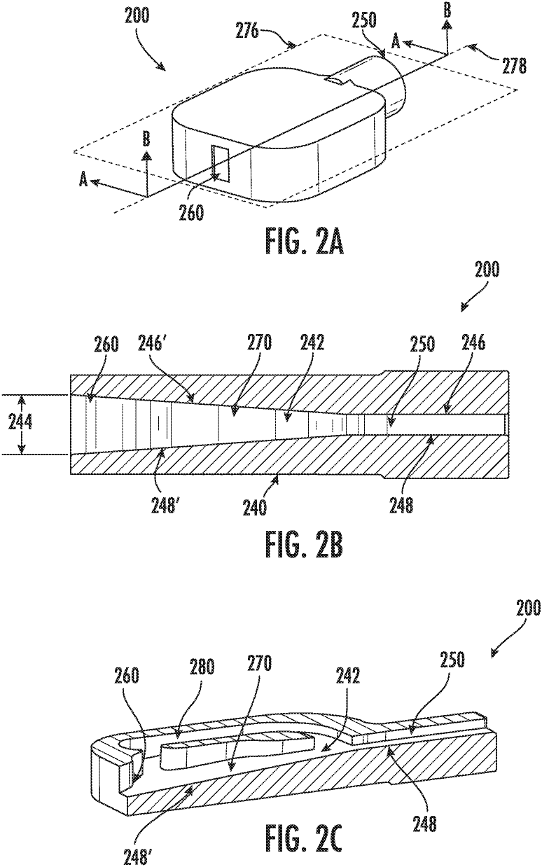

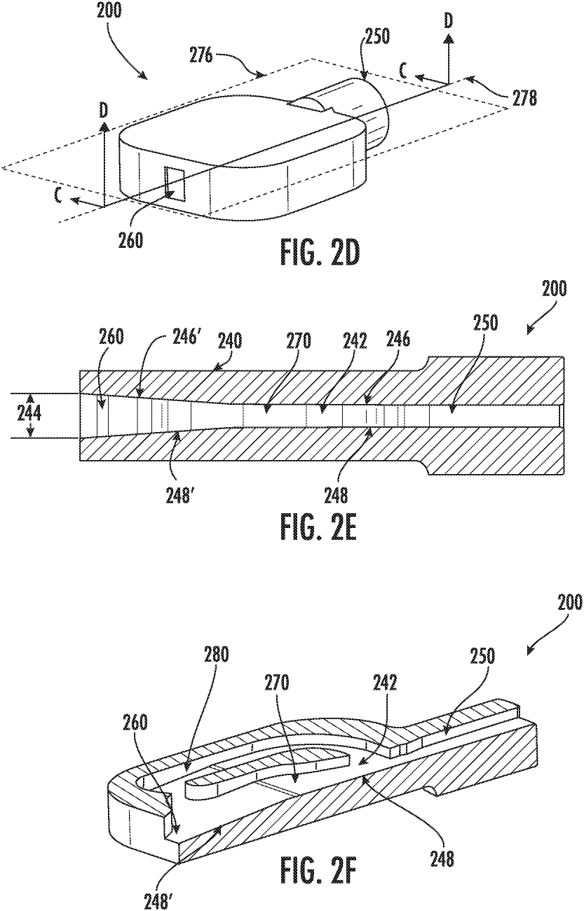

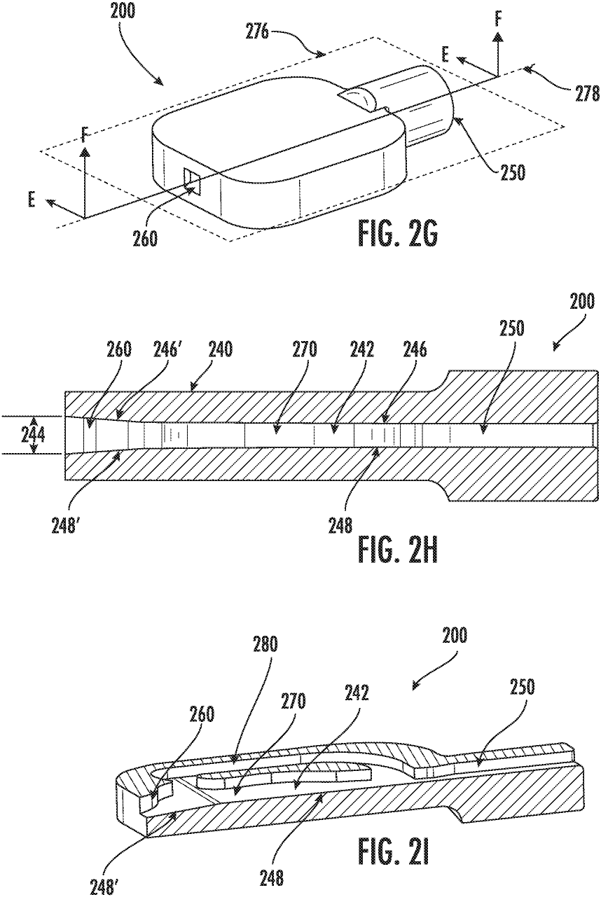

FIGS. 2A-14C show feedback type fluidic oscillator devices with features that are similar to the features of the feedback type fluidic oscillator shown in FIGS. 1A and 1B. However, the fluid stream exiting the outlet nozzle of the feedback type fluidic oscillator shown in FIGS. 1A and 1B is limited to sweeping from side to side in a single plane. Thus, the feedback type fluidic oscillator shown in FIGS. 1A and 1B has a two-dimensional output. The devices shown in FIGS. 2A-14C each include different features that cause the fluid stream exiting the outlet nozzle to discharge in the third dimension as the fluid stream sweeps from side to side.

FIGS. 2A-5B show feedback type fluidic oscillator devices 200, 300, 400, 500 according to one implementation of the present disclosure. The devices 200, 300, 400, 500 each include features similar to the fluidic oscillator 10 shown in FIGS. 1A and 1B, and thus, features of devices 200, 300, 400, 500 are indicated using similar reference numbers.

FIGS. 2A-2C, 2D-2F, and 2G-2I show an implementation of devices 200 with slight variants. Each of the devices 200 includes a first surface 246 and a second surface 248, but a portion 246' of the first surface 246 and a portion 248' of the second surface 248 is tapered. The portions 246', 248' of the first surface 246 and the second surface 248 are tapered such that the inner channel 242 is thicker at the outlet nozzle 260 than at the fluid supply inlet 250. Thus, the maximum thickness 244 of the inner channel 242, as measured from between the first surface 246 and the second surface 248, is at the exit end of the outlet nozzle 260.

The devices 200 shown in FIGS. 2A-2C, 2D-2F, and 2G-2I vary in the length of the portions 246', 248' of the first surface 246 and the second surface 248 that are tapered. The portions 246', 248' of the first surface 246 and the second surface 248 that are tapered in the device 200 shown in FIGS. 2A-2C begin where the fluid supply inlet 250 is coupled to the interaction chamber 270. The portions 246', 248' of the first surface 246 and the second surface 248 that are tapered in the device 200 shown in FIGS. 2D-2F begin midway through the interaction chamber 270. The portions 246', 248' of the first surface 246 and the second surface 248 that are tapered in the device 200 shown in FIGS. 2G-2I begin in the interaction chamber 270 near the outlet nozzle 260. In other implementations, the portions of the first surface and the second surface that are tapered begin anywhere throughout the interaction chamber.

Because portions 246', 248' of the first surface 246 and the second surface 248 are tapered such that the thickness of the inner channel 242 increases toward the outlet nozzle 260, in use the fluid stream exiting the outlet nozzle 260 increases and spreads in a direction perpendicular to the central plane 276 as the exiting fluid stream sweeps along the central plane 276. Thus, in use the devices 200 shown in FIGS. 2A-2C, 2D-2F, and 2G-2I produce an exiting fluid stream that sweeps three-dimensionally.

Although the devices 200 shown in FIGS. 2A-2C, 2D-2F, and 2G-2I include tapered portions 246', 248' of the first surface 246 and the second surface 248, in other implementations, the portions of the first surface and second surface are curved such that the thickness of the inner channel increases toward the outlet nozzle.

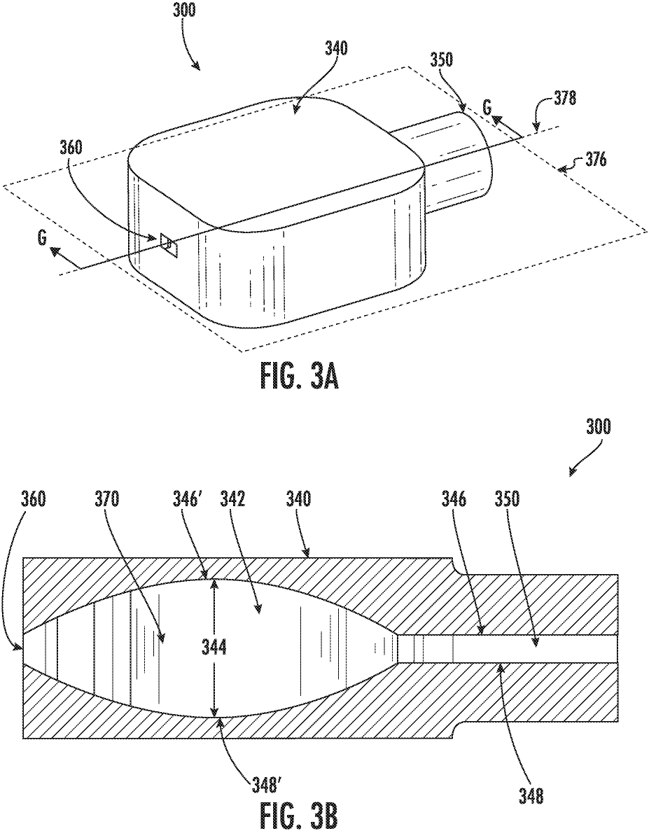

FIGS. 3A and 3B show an implementation of device 300. The device 300 includes a first surface 346 and a second surface 348, wherein a portion 346' of the first surface 346 and a portion 348' of the second surface 348 are curved. The portions 346', 348' of the first surface 346 and the second surface 348 are tapered such that the inner channel 342 is thicker at a midway point of the interaction chamber 370 than at the fluid supply inlet 350 or the outlet nozzle 360. Thus, the maximum thickness 344 of the inner channel 342, as measured from between the first surface 346 and the second surface 348, is at a midway point of the interaction chamber 370.

Because portions 346', 348' of the first surface 346 and the second surface 348 are curved such that the thickness of the inner channel 342 increases toward the midway point of the interaction chamber 370 and then decreases toward the outlet nozzle 360, in use the angle of the fluid stream exiting the outlet nozzle 360 increases and spreads in a direction perpendicular to the central plane 376 as the exiting fluid stream sweeps along the central plane 376. Thus, in use the device 300 shown in FIGS. 3A and 3B produces an exiting fluid stream that sweeps three-dimensionally.

Although the device 300 shown in FIGS. 3A and 3B includes curved portions 346', 348' of the first surface 346 and the second surface 348, in other implementations, the portions of the first surface and second surface are tapered such that the thickness of the inner channel increases toward the midway point of the interaction chamber and then decreases toward the outlet nozzle.

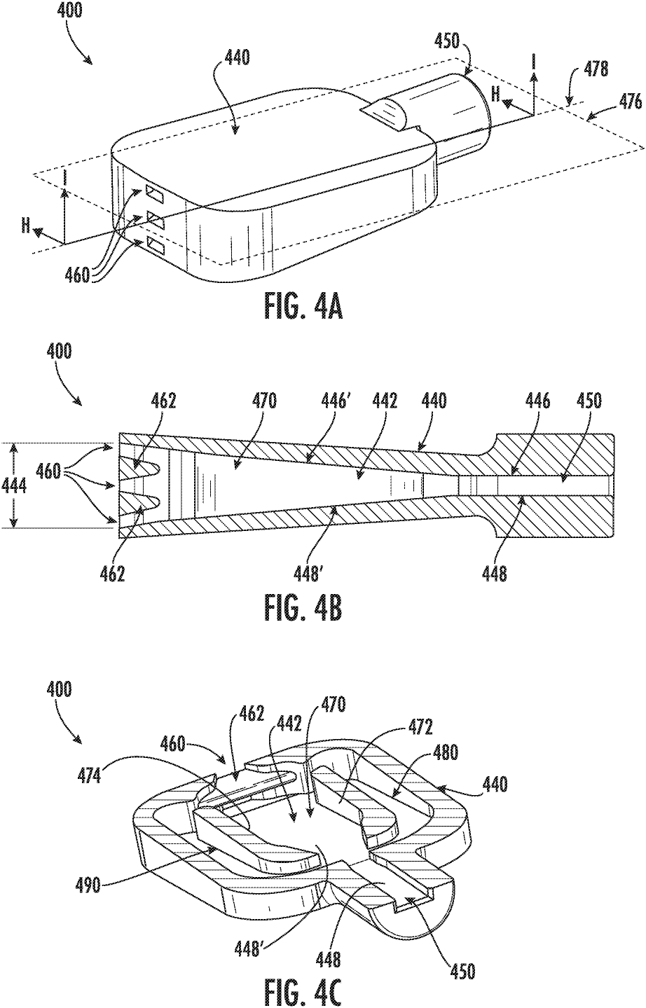

FIGS. 4A-4C show an implementation of a device 400. Similar to the device 200 shown in FIGS. 2A-2C, the device 400 includes portions 446', 448' of the first surface 446 and the second surface 448 that are tapered such that the inner channel 442 is thicker at the outlet nozzle 460 than at the fluid supply inlet 450. Thus, the maximum thickness 444 of the inner channel 442, as measured from between the first surface 446 and the second surface 448, is at the exit end of the outlet nozzle 460.

The portions 446', 448' of the first surface 446 and the second surface 448 of the device 400 shown in FIGS. 4A-4C are tapered beginning where the fluid supply inlet 450 is coupled to the interaction chamber 470. In other implementations, the portions of the first surface and the second surface that are tapered begin anywhere throughout the interaction chamber, similar to the devices 200 shown in FIGS. 2D-2F and 2G-2I.

Because portions 446', 448' of the first surface 446 and the second surface 448 are tapered such that the thickness of the inner channel 442 increases toward the outlet nozzle 460, in use the angle of the fluid stream exiting the outlet nozzle 460 increases and spreads in a direction perpendicular to the central plane 476 as the exiting fluid stream sweeps along the central plane 476. The outlet nozzle 460 of the device 400 also includes two dividers 462 that divide the fluid stream exiting the outlet nozzle 460 into three exiting fluid streams. Because the tapered portions 446', 448' of the first surface 446 and the second surface 448 cause the exiting fluid stream to spread as it exits the outlet nozzle 460 and the dividers 462 separate the exiting fluid stream into three fluid streams, each of the exiting fluid streams exits the outlet nozzle 460 in separate sweeping planes that are transverse to each other. Thus, in use the device 400 shown in FIGS. 4A-4C; produces exiting fluid streams sweeping three-dimensionally.

Although the device 400 shown in FIGS. 4A-4C includes tapered portions 446', 448' of the first surface 446 and the second surface 448, in other implementations, the portions of the first surface and second surface are curved such that the thickness of the inner channel increases toward the outlet nozzle. In some implementations, the device includes only one divider that divide the fluid stream exiting the outlet nozzle into two exiting fluid streams or three or more dividers that divide the fluid stream exiting the outlet nozzle into four or more exiting fluid streams.

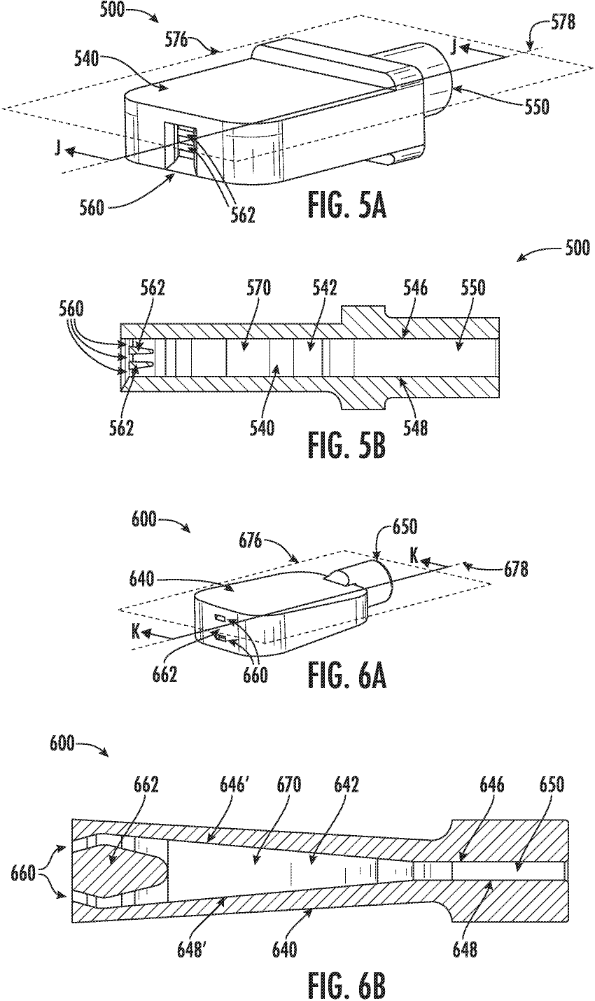

FIGS. 5A and 5B show an implementation of a device 500. Similar to the device 400 shown in FIGS. 4A-4C, the outlet nozzle 560 of the device 500 also includes two dividers 562 that divide the fluid stream exiting the outlet nozzle 560 into three exiting fluid streams. However, the first surface 546 and the second surface 548 of the device 500 shown in FIGS. 5A and 5B do not include tapered portions.

The dividers 562 restrict the outlet nozzle 560 and cause turbulence in the exiting fluid stream, and the relative angles of the dividers 562, cause each of the exiting fluid streams to exit the outlet nozzle 560 in separate sweeping planes that are transverse to each other. Thus, in use the device 500 shown in FIGS. 5A and 5B produces exiting fluid streams sweeping three-dimensionally.

Although the device 500 shown in FIGS. 5A and 5B includes two dividers 562 that divide the fluid stream exiting the outlet nozzle 560 into three exiting fluid streams, in some implementations, the device includes only one divider that divides the fluid stream exiting the outlet nozzle into two exiting fluid streams or three or more dividers that divide the fluid stream exiting the outlet nozzle into four or more exiting fluid streams.

FIGS. 6A and 6B show a device 600 similar in some features to the device shown in FIGS. 4A-4C. However, the device 600 shown in FIGS. 6A and 6B includes only one divider 662 and the outlet nozzle 660 is angled such that, in use, the two fluid streams exiting the outlet nozzle 660 on either side of the divider 662 collide with each other after exiting the device 600. As the exiting fluid streams collide with each other, the two fluid streams break apart into small droplets and are atomized. Because the two exiting fluid streams oscillate in phase with each other, the fluid streams are constantly colliding with each other as they oscillate, causing the point of collision to move from side to side. Thus, the atomization of the fluid streams is produced at a wider angle and results in a more even coverage than if the colliding fluid streams were not oscillating.

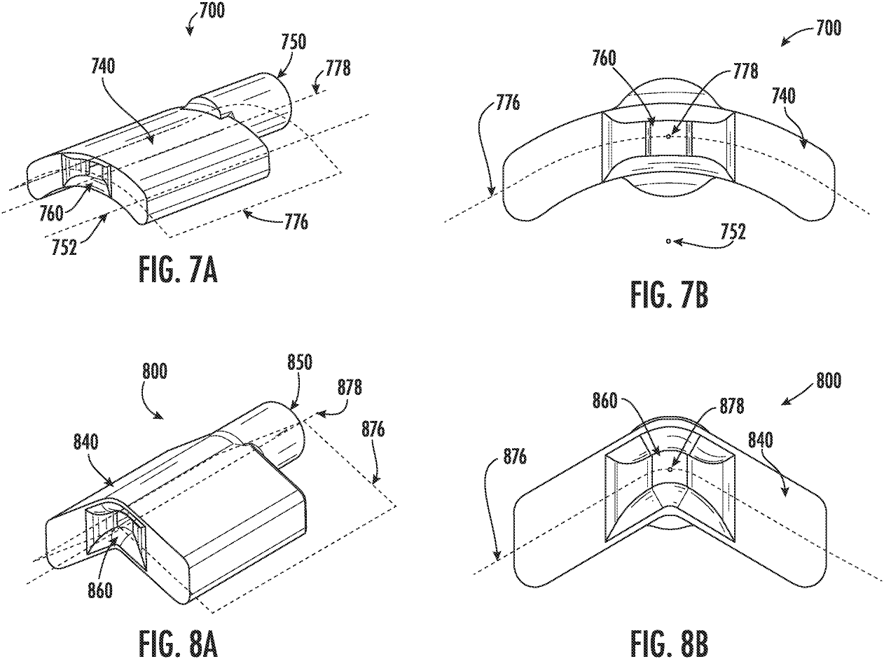

FIGS. 7A, 7B, 8A, and 8B show feedback type fluidic oscillator devices 700 and 800 according to two implementations of the present disclosure. The devices 700 and 800 each include some features similar to the fluidic oscillator 10 shown in FIGS. 1A and 1B, and thus, features of devices 700 and 800 are indicated using similar reference numbers. However, the central planes 776, 876 of the devices 700, 800 shown in FIGS. 7A, 7B, 8A, and 8B are shaped in a way that the outlet nozzle 760, 860 has a cross-sectional shape in a plane perpendicular to the central longitudinal axis 778, 878 that is a bent rectangle. In use, the bent rectangle cross-sectional shape of the outlet nozzles 760, 860 causes the fluid stream exiting the outlet nozzle 760, 860 to sweep three-dimensionally.

FIGS. 7A and 7B show an implementation of device 700 wherein the central plane 776 is curved circumferentially around an axis 752 that is parallel to the central longitudinal axis 778 of the device 700. As a result, the cross-sectional shape of the outlet nozzle 760 in a plane perpendicular to the central longitudinal axis 778 is a bent rectangle. More specifically, the cross-sectional shape of the outlet nozzle 760 is a curved rectangle. The first surface 746 and the second surface 748 of the inner channel 742 of the device 700 have the same radius of curvature in the plane perpendicular to the central longitudinal axis 778. Because the central plane 776 and outlet nozzle 760 opening are curved, in use the fluid stream flowing through the inner channel 742 and exiting the outlet nozzle 760 oscillates three-dimensionally in a curved sweeping plane.

FIGS. 8A and 8B show an implementation of device 800 wherein the central plane 876 is bent at an angle along the central longitudinal axis 878 of the device 800. As a result, the cross-sectional shape of the outlet nozzle 860 in a plane perpendicular to the central longitudinal axis 878 is a bent rectangle. More specifically, the cross-sectional shape of the outlet nozzle 860 is a v-shaped rectangle. The first surface 846 and the second surface 848 of the inner channel 842 are bent at the same angle in the plane perpendicular to the central longitudinal axis 878. Because the central plane 876 and outlet nozzle 860 opening are bent at an angle, in use the fluid stream flowing through the inner channel 842 and exiting the outlet nozzle 860 oscillates three-dimensionally in a v-shaped sweeping plane.

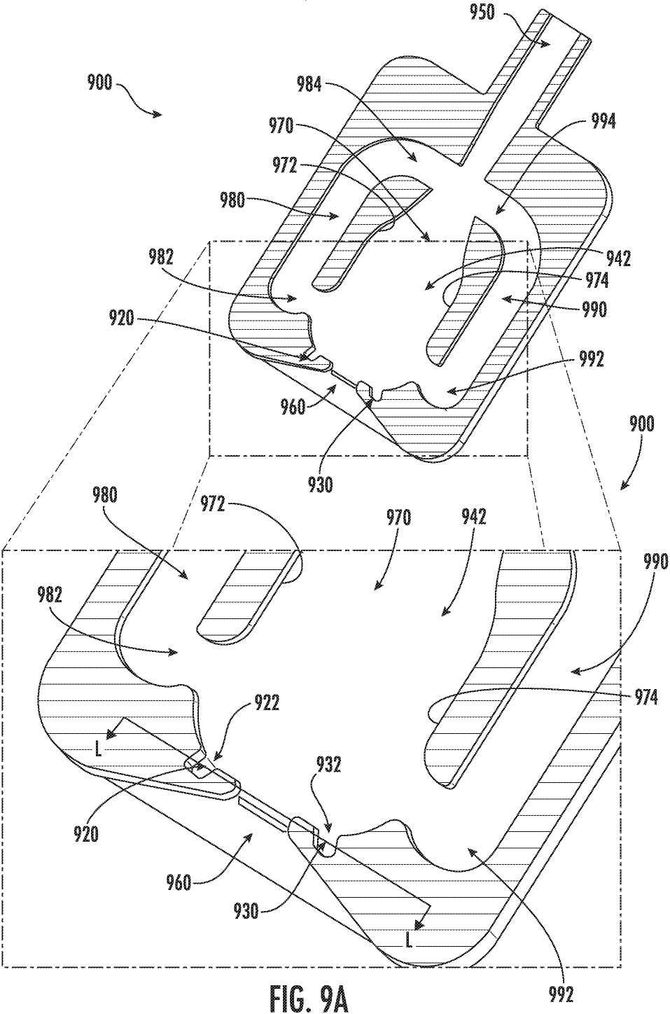

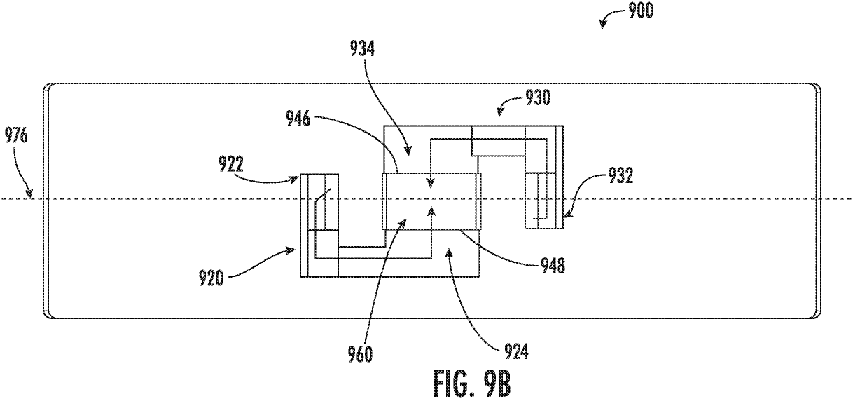

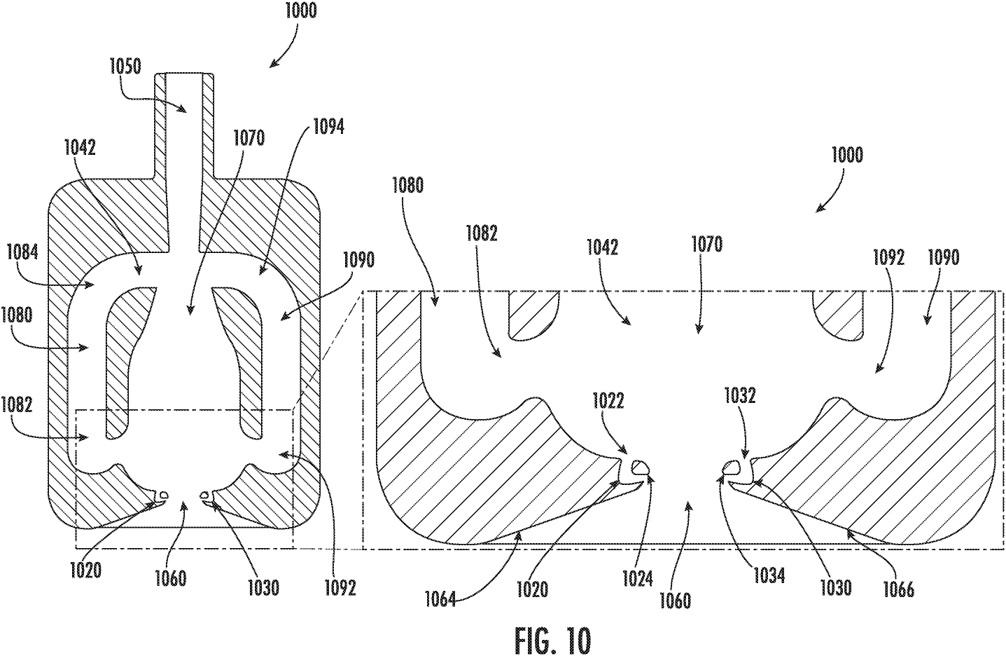

FIGS. 9A, 9B, and 10 show feedback type fluidic oscillator devices 900, 1000 according to two implementations of the present disclosure. The devices 900, 1000 each include some features similar to the fluidic oscillator 10 shown in FIGS. 1A and 1B, and thus, features of devices 900, 1000 are indicated using similar reference numbers. However, the devices 900, 1000 shown in FIGS. 9A, 9B, and 10 include secondary feedback channels 920, 930, 1020, 1030. Each secondary feedback channel 920, 930, 1020, 1030 has a first end 922, 932, 1022, 1032 and a second end 924, 934, 1024, 1034 opposite and spaced apart from the first end 922, 932, 1022, 1032 of the secondary feedback channel 920, 930, 1020, 1030. The first end 922, 932, 1022, 1032 of the secondary feedback channel 920, 930, 1020, 1030 is in fluid communication with either (1) the interaction chamber 970, 1070, or (2) one of the first feedback channel 980, 1080 or the second feedback channel 990, 1090. A second end 924, 934, 1024, 1034 of the secondary feedback channel 920, 930, 1020, 1030 is in fluid communication with a portion of the outlet nozzle 960, 1060. The first end 922, 932, 1022, 1032 of the secondary feedback channel 920, 930, 1020, 1030 is positioned to allow fluid from the fluid stream to flow into the first end 922, 932, 1022, 1032 of the secondary feedback channel 920, 930, 1020, 1030 and out of the second end 924, 934, 1024, 1034 of the secondary feedback channel 920, 930, 1020, 1030 and to interact with the fluid stream in the outlet nozzle 960, 1060. The collision of the fluid streams exiting the secondary feedback channels 920, 930, 1020, 1030 and the main fluid stream flowing through the outlet nozzle 960, 1060 influences the fluid stream exiting the outlet nozzle 960, 1060 to alter the typical sweeping pattern of the fluid stream.

FIGS. 9A and 9B show an implementation of device 900 including first secondary feedback channel 920 and a second secondary feedback channel 930. The first end 922 of the first secondary feedback channel 920 is defined by a wall of the interaction chamber 970 located between the first end 982 of the first feedback channel 980 and the outlet nozzle 960. The first end 932 of the second secondary feedback channel 930 is defined by a wall of the interaction chamber 970 located between the first end 992 of the second feedback channel 990 and the outlet nozzle 960. The second end 924 of the first secondary feedback channel 920 is defined by a portion of the second surface 948 of the inner channel 942 defining the outlet nozzle 960, and the second end 934 of the second secondary feedback channel 930 is defined by a portion of the first surface 946 of the inner channel 942 defining the outlet nozzle 960.

When the fluid stream flows along the first attachment wall 972 of the interaction chamber 970, a portion of the fluid stream enters the first end 922 of the first secondary feedback channel 920. The portion of the fluid stream flows through the first secondary feedback channel 920 and out of the second end 924 of the first secondary feedback channel 920. As the portion of the fluid stream flows out of the first secondary feedback channel 920, the portion of the fluid stream collides with the main fluid stream flowing through the outlet nozzle 960. Because the second end 924 of the first secondary feedback channel 920 is defined by the first surface 946, the portion of the fluid stream causes the main fluid stream to angle toward the second surface 948 of the device 900.

When the fluid stream sweeps across the interaction chamber 970 from the first attachment wall 972 to the second attachment wall 974, a portion of the fluid stream enters the first end 932 of the second secondary feedback channel 930. The portion of the fluid stream flows through the second secondary feedback channel 930 and out of the second end 934 of the second secondary feedback channel 930. As the portion of the fluid stream flows out of the second secondary feedback channel 930, the portion of the fluid stream collides with the main fluid stream flowing through the outlet nozzle 960. Because the second end 934 of the second secondary feedback channel 930 is defined by the second surface 948, the portion of the fluid stream causes the main fluid stream to angle toward the first surface 946 of the device 900.

Thus, in use, as the fluid stream exiting the outlet nozzle 960 sweeps from side to side in a direction along the central plane 976, the first and second secondary feedback channels 920, 930 cause the exiting fluid stream to sweep up and down transverse to the central plane 976, creating a three-dimensional output.

Although FIGS. 9A and 9B show implementations of feedback type fluidic oscillator devices 900, in other implementations, a jet interact type fluidic oscillator device includes secondary feedback channels similar to the secondary feedback channels described above. The secondary feedback channels included in the jet interact type fluidic oscillator device have first ends defined by the interaction chamber and second sends in fluid communication with the first and second surfaces of the outlet nozzle. The secondary feedback channels included in the jet interact type fluidic oscillator device cause the exiting fluid stream to sweep up and down transverse to the central plane, creating a three-dimensional output.

FIG. 10 shows an implementation of device 1000 including first secondary feedback channel 1020 and a second secondary feedback channel 1030. The first end 1022 of the first secondary feedback channel 1020 is defined by a wall of the interaction chamber 1070 located between the first end 1082 of the first feedback channel 1080 and the outlet nozzle 1060. The first end 1032 of the second secondary feedback channel 1030 is defined by a wall of the interaction chamber 1070 located between the first end 1092 of the second feedback channel 1090 and the outlet nozzle 1060. The second end 1024 of the first secondary feedback channel 1020 is defined by a first side wall 1064 of the outlet nozzle 1060, and the second end 1034 of the second secondary feedback channel 1030 is defined by a second side wall 1066 of the outlet nozzle 1060. The first side wall 1064 and the second side wall 1066 are opposite and spaced apart from each other.

When the fluid stream flows along the first attachment wall 1072 of the interaction chamber 1070, a portion of the fluid stream enters the first end 1022 of the first secondary feedback channel 1020. The portion of the fluid stream flows through the first secondary feedback channel 1020 and out of the second end 1024 of the first secondary feedback channel 1020. As the portion of the fluid stream flows out of the first secondary feedback channel 1020, the portion of the fluid stream collides with the main fluid stream flowing through the outlet nozzle 1060. Because the second end 1024 of the first secondary feedback channel 1020 is defined by the first side wall 1064 of the outlet nozzle 1060, in use the portion of the fluid stream causes the main fluid stream to angle toward the second side wall 1066 of the outlet nozzle 1060.

When the fluid stream sweeps across the interaction chamber 1070 from the first attachment wall 1072 to the second attachment wall 1074, a portion of the fluid stream enters the first end 1032 of the second secondary feedback channel 1030. The portion of the fluid stream flows through the second secondary feedback channel 1030 and out of the second end 1034 of the second secondary feedback channel 1030. As the portion of the fluid stream flows out of the second secondary feedback channel 1030, the portion of the fluid stream collides with the main fluid stream flowing through the outlet nozzle 1060. Because the second end 1034 of the second secondary feedback channel 1030 is defined by the second side wall 1066 of the outlet nozzle 1060, the portion of the fluid stream causes the main fluid stream to angle toward the first side wall 1064 of the outlet nozzle 1060.

Thus, as the fluid stream exiting the outlet nozzle 1060 sweeps from side to side in a direction along the central plane 1076, the first and second secondary feedback channels 1020, 1030 cause the exiting fluid stream to sweep further from side to side.

Although FIG. 10 show an implementation of a feedback type fluidic oscillator device 1000, in other implementations, a jet interact type fluidic oscillator device includes secondary feedback channels similar to the secondary feedback channels described above. The secondary feedback channels included in the jet interact type fluidic oscillator device have first ends defined by the interaction chamber and second sends in fluid communication with the first and second side walls of the outlet nozzle. The secondary feedback channels included in the jet interact type fluidic oscillator device cause the exiting fluid stream to sweep further from side to side.

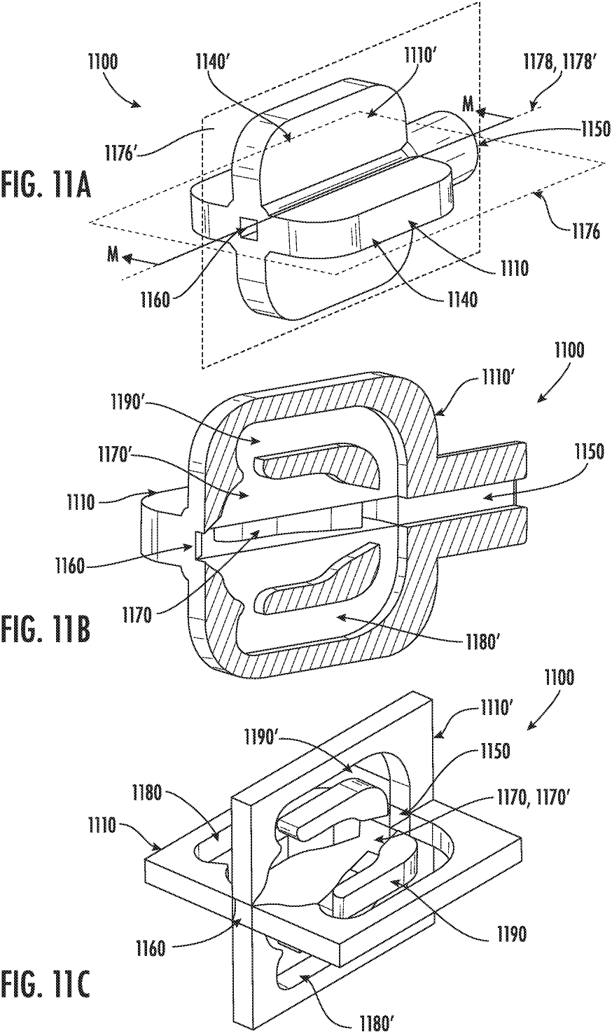

FIGS. 11A-11C, 12A-12C, and 13 show feedback type fluidic oscillator devices 1100, 1200, 1300 according to three implementations of the present disclosure. The devices 1100, 1200, 1300 each include fluidic oscillators 1110, 1110', 1210, 1210', 1310, 1310' with some features similar to the fluidic oscillator 10 shown in FIGS. 1A and 1B, and thus, similar features of the fluidic oscillators 1110, 1110', 1210, 1210', 1310, 1310' of devices 1100, 1200, 1300 are indicated using similar reference numbers. Each of the devices 1100, 1200, 1300 includes at least two fluidic oscillators 1110, 1110', 1210, 1210', 1310, 1310', and the central planes 1176, 1176', 1276, 1276', 1376, 1376' of the at least two fluidic oscillators 1110, 1110', 1210, 1210', 1310, 1310' are transverse to each other. The interaction of the at least two fluidic oscillators 1110, 1110', 1210, 1210', 1310, 1310’ cause the fluid stream exiting the outlet nozzle 1160, 1260, 1360 of one of the at least two fluidic oscillators 1110, 1110', 1210, 1210', 1310, 1310' to sweep three-dimensionally.

FIGS. 11A-11C show an implementation of device 1100 including a first fluidic oscillator 1110 and a second fluidic oscillator 1110'. The central plane 1176 of the first fluidic oscillator 1110 is perpendicular to the central plane 1176' of the second fluidic oscillator 1110', and the central longitudinal axis 1178 of the first fluidic oscillator 1110 is coincident with the central longitudinal axis 1178' of the second fluidic oscillator 1110'. The first and second fluidic oscillators 1110, 1110' overlap such that the interaction chamber 1170 of the first fluidic oscillator 1110 is directly in fluid communication with the interaction chamber 1170' of the second fluidic oscillator 1110'. The first and second fluidic oscillators 1110, 1110' also share the same fluid supply inlet 1150 and the outlet nozzle 1160.

As the fluid stream enters the interaction chambers 1170, 1170' of the first and second fluidic oscillators 1110, 1110', the fluid stream attaches to one of the first or second attachment wall 1172, 1174, 1172', 1174' of either the first or second fluidic oscillator 1110, 1110'. When the fluid stream begins to oscillate away from this attachment wall 1172, 1174, 1172', 1174', the fluid stream attaches to another of the first or second attachment wall 1172, 1174, 1172', 1174' of either the first or second fluidic oscillator 1110, 1110'. Because the first and second fluidic oscillators 1110, 1110' are perpendicular to each other, the fluid stream exiting the shared outlet nozzle 1160 can sweep from side to side along the central plane 1176 of the first fluidic oscillator 1110 and up and down along the central plane 1176' of the second fluidic oscillator 1110'. Thus, the exiting fluid stream sweeps three-dimensionally as the fluid stream exits the shared outlet nozzle 1160.

Although the device 1100 shown in FIGS. 11A-11C includes two fluidic oscillators 1110, 1110', in some implementations, the device includes three or more fluidic oscillators. The central plane of each of the fluidic oscillators is transverse to the central plane of each of the other fluidic oscillators, and the central longitudinal axes of each of the fluidic oscillators are coincident with each other. The fluidic oscillators overlap such that the interaction chambers of each of the fluidic oscillators is directly in fluid communication with the interaction chambers of each of the other fluidic oscillators. Each of the fluidic oscillators also shares the same fluid supply inlet and outlet nozzle. In some implementations, the central plane of the first fluidic oscillator is transverse to the central plane of the second fluidic oscillator.

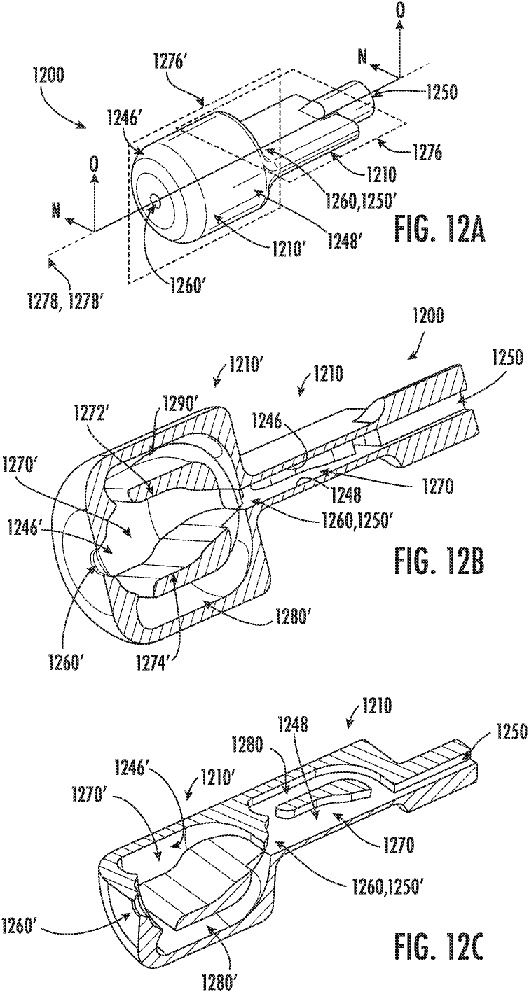

FIGS. 12A-12C show an implementation of device 1200 including a first fluidic oscillator 1210 and a second fluidic oscillator 1210'. The central plane 1276 of the first fluidic oscillator 1210 is perpendicular to the central plane 1276' of the second fluidic oscillator 1210', and the central longitudinal axis 1278 of the first fluidic oscillator 1210 is coincident with the central longitudinal axis 1278' of the second fluidic oscillator 1210'. However, unlike the device 1100 shown in FIGS. 11A-11C, the first and second fluidic oscillators 1210, 1210' do not overlap. Instead, the outlet nozzle 1260 of the first fluidic oscillator 1210 acts as the fluid supply inlet 1250' of the second fluidic oscillator 1210'. The first and second surfaces 1246', 1248' of the second fluidic oscillator 1210' are both curved circumferentially around the central longitudinal axis 1278' such that the first and second surfaces 1246', 1248' have semicircular cross-sections in a plane perpendicular to the central longitudinal axis 1278'.

As the fluid stream exits the first fluidic oscillator 1210, the fluid stream sweeps from side to side along the central plane 1276 of the first fluidic oscillator 1210. Because the first and second fluidic oscillators 1210, 1210' are perpendicular to each other, the sweeping fluid stream exiting the first fluidic oscillator 1210 and entering the second fluidic oscillator 1210' is able to also sweep up and down in the interaction chamber 1270' of the second fluidic oscillator 1210. The semicircular shape of the first and second surfaces 1246', 1248' of the second fluidic oscillator 1210' allows the fluid stream from the first oscillator 1210 to sweep from side to side in the second fluidic oscillator 1210' while the fluid stream begins to sweep up and down in a direction parallel to the central plane 1276' of the second fluidic oscillator 1210. The resulting fluid stream exiting the outlet nozzle 1260' of the second fluidic oscillator 1210 sweeps three-dimensionally.

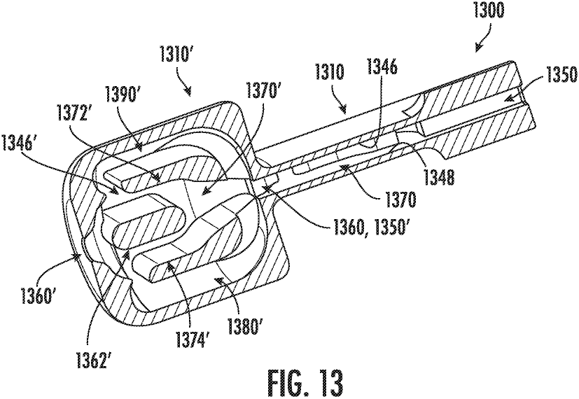

FIG. 13 shows an implementation of device 1300 including a first fluidic oscillator 1310 and a second fluidic oscillator 1310'. The device 1300 is similar to the device 1200 shown in FIGS. 12A-12C, but the second fluidic oscillator of the device 1300 shown in FIG. 13 includes a divider 1362' disposed between the first attachment wall 1372' and the second attachment wall 1374' of the second fluidic oscillator 1310'. The divider 1362' helps to cause the fluid stream to attach to one of the first attachment wall 1372' and second attachment wall 1374' of the second fluidic oscillator 1310' when the fluid stream enters the interaction chamber 1370' of the second fluidic oscillator 1310'. Thus, the divider 1362' helps to ensure a three-dimensional fluid output.

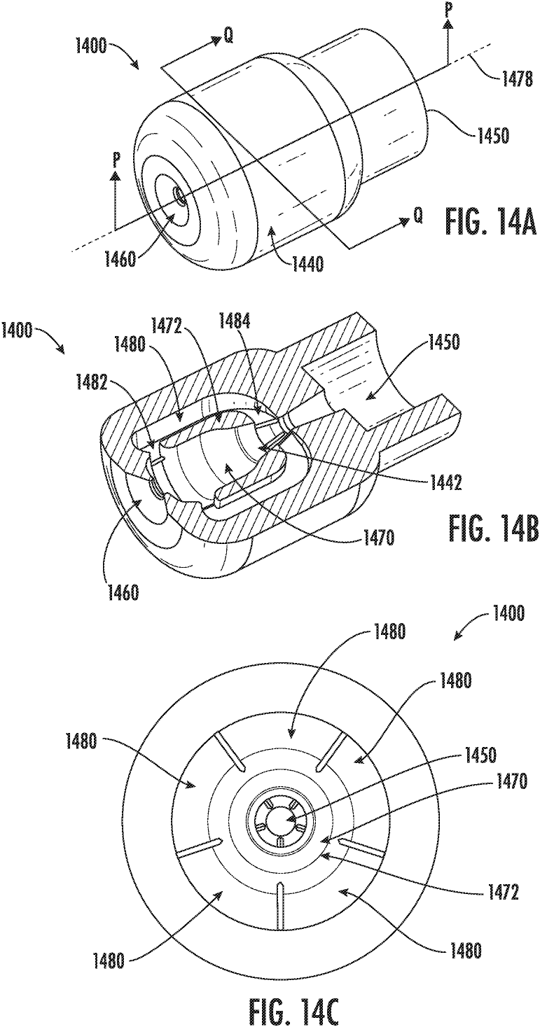

FIGS. 14A-14C show a fluidic oscillator device 1400 with three-dimensional output according to an implementation of the present disclosure. The device 1400 includes a body 1440 defining an inner channel 1442. The inner channel 1442 of the body 1440 includes an interaction chamber 1470, a fluid supply inlet 1450, an outlet nozzle 1460, five feedback channels 1480, and a central longitudinal axis 1478.

The interaction chamber 1470 is defined by an annular attachment wall 1472 extending circumferentially around the central longitudinal axis 1478. The annular attachment wall 1472 has a curvature such that the annular attachment wall 1472 is narrower adjacent the fluid supply inlet 1450 than adjacent the outlet nozzle 1460, as discussed below.

The fluid supply inlet 1450 of the body 1440 is in fluid communication with the interaction chamber 1470. In use, a fluid stream is introduced from the fluid supply inlet 1450 into the interaction chamber 1470.

The outlet nozzle 1460 of the body 1440 is in fluid communication with the interaction chamber 1470 and is located downstream of the fluid supply inlet 1450. The central axis 1478 extends from the fluid supply inlet 1450, through the interaction chamber 1470, to the exiting end of the outlet nozzle 1460. In use, the fluid stream exits the interaction chamber 1470 through the outlet nozzle 1460.

The feedback channels 1480 each have a first end 1482 and a second end 1484 opposite and spaced apart from the first end 1482. Each of the feedback channels 1480 is coupled to the annular attachment wall 1472 such that each of the feedback channels 1480 is in fluid communication with the interaction chamber 1470. The first end 1482 of each of the feedback channels 1480 is adjacent the outlet nozzle 1460 such that the first end 1482 of the feedback channel 1480 is closer than the second end 1484 of the feedback channel 1480 to the outlet nozzle 1460. The second end 1484 of each of the feedback channels 1480 is adjacent the fluid supply inlet 1450 such that the second end 1484 of the feedback channel 1480 is closer than the first end 1482 of the feedback channel 1480 to the fluid supply inlet 1450.

In use, a fluid stream enters the fluidic oscillator device 1400 through the fluid supply inlet 1450, flows through the interaction chamber 1470, and eventually exits the device 1400 through the outlet nozzle 1460. The annular attachment wall 1472 of the interaction chamber 1470 has a predetermined shape and size such that, as the fluid stream flows through the interaction chamber 1470, a pressure difference across the fluid stream causes the fluid stream to deflect toward, and eventually attach to, a portion of the annular attachment wall 1472 due to the Coanda effect. The annular attachment wall 1472 of the interaction chamber 1470 is shaped to allow fluid from the fluid stream to flow into the first ends 1482 of one of the feedback channels 1480 when the fluid stream is attached to an adjacent portion of the attachment wall 1472. The fluid stream can include any fluid, for example, any liquid or gas.

When the fluid stream is attached to a portion of the annular attachment wall 1472, fluid from the fluid stream enters the first end 1482 of one of the feedback channels 1480, flows through the feedback channel 1480 and out of the second end 1484 of the feedback channel 1480. The fluid exiting the second end 1484 of the feedback channel 1480 contacts the fluid stream adjacent the fluid supply inlet 1450, causing the fluid stream to detach from the annular attachment wall 1472 and attach to a different portion of the annular attachment wall 1472. Fluid from the fluid stream then enters the first end 1482 of another of the feedback channels 1480, flows through the feedback channel 1480 and out of the second end 1484 of the feedback channel 1480. The fluid exiting the second end 1484 of the feedback channel 1480 contacts the fluid stream adjacent the fluid supply inlet 1450, causing the fluid stream to again detach from the annular attachment wall 1472 and attach back to another portion of the annular attachment wall 1472. The fluid stream continues to oscillate between attachment to different portions of the annular attachment wall 1472 of the interaction chamber 1470.

Because of the shape of the outlet nozzle 1460 and the curvature of the annular attachment wall 1472, the oscillation of the fluid stream between different portions of the annular attachment wall 1472 causes the fluid stream to oscillate as the fluid stream exits the device 1400 through the outlet nozzle 1460. Since the attachment wall 1472 in the device 1400 is annular, the fluid stream exiting the device 1400 through the outlet nozzle 1460 sweeps three-dimensionally.

Although the device 1400 shown in FIGS. 14A-14C includes five feedback channels 1480, in other implementations, the device includes three, four, or six or more feedback channels. Although the feedback channels 1480 of the device 1400 shown in FIGS. 14A-14C are all equally spaced circumferentially around the interaction chamber 1470, in other implementations, the feedback channels are not equally spaced circumferentially around the interaction chamber such that the sweeping of the exiting fluid stream sweeps more frequently to one side than other sides.

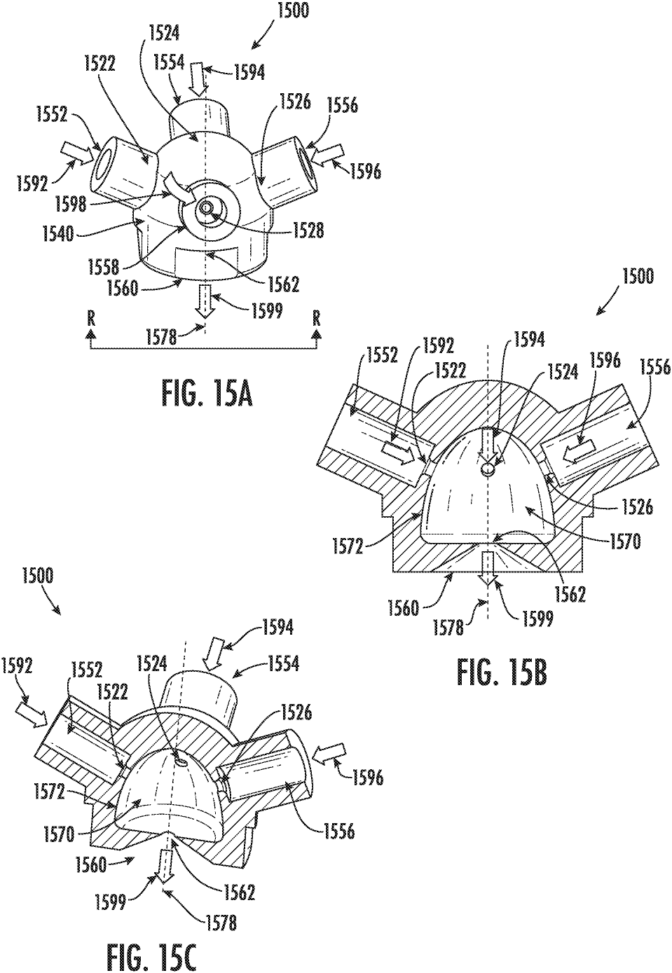

FIGS. 15A-15C show a jet interaction type fluidic oscillator device 1500 with three-dimensional output according to an implementation of the present disclosure. The jet interaction-type fluidic oscillator device 1500 includes a body 1540 including a dome-shaped wall 1572 defining an inner chamber. The inner chamber includes an interaction chamber 1570, a first inlet port 1522, a second inlet port 1524, a third inlet port 1526, a fourth inlet port 1528, and an outlet port 1562.

The body 1540 of the device 1500 further defines a first fluid supply inlet 1552, a second fluid supply inlet 1554, a third fluid supply inlet 1556, a fourth fluid supply inlet 1558, and an outlet nozzle 1560. The first fluid supply inlet 1552 is in fluid communication with the interaction chamber 1570 via the first inlet port 1522. The second fluid supply inlet 1554 is in fluid communication with the interaction chamber 1570 via the second inlet port 1524. The third fluid supply inlet 1556 is in fluid communication with the interaction chamber 1570 via the third inlet port 1526. The fourth fluid supply inlet 1558 is in fluid communication with the interaction chamber 1570 via the fourth inlet port 1528. The outlet nozzle 1560 is in fluid communication with the interaction chamber 1570 via the outlet port 1562. The central axis 1578 of the outlet nozzle 1560 extends from the interaction chamber 1570 to the exiting end of the outlet nozzle 1560.

In use, a first inlet fluid stream 1592 enters the interaction chamber 1570 of the device 1500 through the first fluid supply inlet 1552, through the first inlet port 1522, through the interaction chamber 1570, and exits the device 1500 through the outlet port 1562 and the outlet nozzle 1560. Simultaneously, a second inlet fluid stream 1594 enters the device 1500 through the second fluid supply inlet 1554, through the second inlet port 1524, through the interaction chamber 1570, and exits the device 1500 through the outlet port 1562 and the outlet nozzle 1560. A third inlet fluid stream 1596 enters the device 1500 through the third fluid supply inlet 1556, through the third inlet port 1526, through the interaction chamber 1570, and exits the device 1500 through the outlet port 1562 and the outlet nozzle 1560. A fourth inlet fluid stream 1598 enters the device 1500 through the fourth fluid supply inlet 1558, through the fourth inlet port 1528, through the interaction chamber 1570, and exits the device 1500 through the outlet port 1562 and the outlet nozzle 1560. The first, second, third, and fourth inlet fluid streams 1592, 1594, 1596, 1598 are angled to collide with each other in the interaction chamber 1570. As the inlet fluid streams 1592, 1594, 1596, 1598 collide in the interaction chamber 1570, vortices are created in the interaction chamber 1570, causing the outlet fluid stream to sweep three-dimensionally as the outlet fluid stream exits the interaction chamber 1570 through the outlet port 1562 and the outlet nozzle 1560.

Although the device 1500 shown in FIGS. 15A-15C includes four fluid supply inlets 1552, 1554, 1556, 1558 and four inlet ports 1522, 1524, 1526, 1528, in other implementations, the device includes three fluid supply inlets and three inlet ports, or five or more fluid supply inlets and five or more inlet ports. Although the inlet ports 1522, 1524, 1526, 1528 of the device 1500 shown in FIGS. 15A-15C are all equally spaced circumferentially around the dome-shaped wall 1572 of the interaction chamber 1570, in other implementations, the inlet ports are not equally spaced circumferentially around dome-shaped wall of the interaction chamber, such that the sweeping of the outlet fluid stream sweeps more frequently to one side than other sides.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

1. A feedback type fluidic oscillator device with three-dimensional output, the device comprising:
a body having a first surface and a second surface spaced apart from the first surface, wherein the first surface and the second surface at least partially define an inner channel, the inner channel comprising:
an interaction chamber having a first attachment wall and a second attachment wall extending between the first surface and the second surface, the first attachment wall and the second attachment wall being opposite and spaced apart from each other,
a fluid supply inlet configured to introduce a fluid stream into the interaction chamber,
an outlet nozzle downstream of the fluid supply inlet, wherein the fluid stream exits the interaction chamber through the outlet nozzle, and
a first feedback channel coupled to the first attachment wall and a second feedback channel coupled to the second attachment wall, the first feedback channel and second feedback channel being in fluid communication with the interaction chamber, each of the first feedback channel and second feedback channel having a first end and a second end opposite and spaced apart from the first end, wherein the first end is adjacent the outlet nozzle and the second end is adjacent the fluid supply inlet, wherein the first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber;
wherein the sweeping of the fluid stream between the first attachment wall and second attachment wall of the interaction chamber causes the fluid stream exiting the outlet nozzle to sweep; and
wherein a portion of the inner channel has a maximum thickness, as measured from between the first surface and the second surface, that is thicker than another portion of the inner channel such that the fluid stream exiting the outlet nozzle sweeps three-dimensionally.

2. The device of claim 1, wherein a portion of the inner channel has an increasing thickness, as measured from between the first surface and the second surface, such that the portion of the inner channel with the maximum thickness is the outlet nozzle.

3. The device of claim 2, wherein the portion of the inner channel that has the increasing thickness is a tapered portion of the inner channel.

4. The device of claim 2, wherein the portion of the inner channel that has the increasing thickness is a curved portion of the inner channel.

5. The device of claim 1, wherein a portion of the inner channel has an increasing thickness and a decreasing thickness, as measured from between the first surface and the second surface, such that the portion of the inner channel with the maximum thickness is the interaction chamber.

6. The device of claim 5, wherein the portion of the inner channel that has the increasing thickness and the decreasing thickness is a tapered portion of the inner channel.

7. The device of claim 5, wherein the portion of the inner channel that has the increasing thickness and the decreasing thickness is a curved portion of the inner channel.

8. The device of claim 1, wherein the outlet nozzle includes one or more dividers configured to divide the fluid stream exiting the outlet nozzle into two or more exiting fluid streams, wherein each of the two or more exiting fluid streams sweep in a separate sweeping plane.

9. A feedback type fluidic oscillator device with three-dimensional output, the device comprising:
a body having a first surface, a second surface spaced apart from the first surface, and a central longitudinal axis, wherein the first surface and the second surface at least partially define an inner channel, the inner channel comprising:
an interaction chamber having a first attachment wall and a second attachment wall extending between the first surface and the second surface, the first attachment wall and the second attachment wall being opposite and spaced apart from each other,
a fluid supply inlet configured to introduce a fluid stream into the interaction chamber,
an outlet nozzle downstream of the fluid supply inlet, wherein the fluid stream exits the interaction chamber through the outlet nozzle, and
a first feedback channel coupled to the first attachment wall and a second feedback channel coupled to the second attachment wall, the first feedback channel and second feedback channel being in fluid communication with the interaction chamber, each of the first feedback channel and second feedback channel having a first end and a second end opposite and spaced apart from the first end, wherein the first end is adjacent the outlet nozzle and the second end is adjacent the fluid supply inlet, wherein the first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber;
wherein the sweeping of the fluid stream between the first attachment wall and second attachment wall of the interaction chamber causes the fluid stream exiting the outlet nozzle to sweep; and
wherein the outlet nozzle has a cross-sectional shape in a plane perpendicular to the central longitudinal axis, wherein the cross-sectional shape is a bent rectangle such that the fluid stream exiting the outlet nozzle sweeps three-dimensionally.

10. The device of claim 9, wherein the bent rectangle is a curved rectangle.

11. The device of claim 10, wherein the first surface and the second surface of the inner channel have the same radius of curvature in the plane perpendicular to the central longitudinal axis.

12. The device of claim 9, wherein the bent rectangle is a v-shaped rectangle.

13. The device of claim 12, wherein the first surface and the second surface of the inner channel are bent at a same angle in the plane perpendicular to the central longitudinal axis.

14. A feedback type fluidic oscillator device with three-dimensional output, the device comprising:
a body having a first surface and a second surface spaced apart from the first surface, wherein the first surface and the second surface at least partially define an inner channel, the inner channel comprising:
an interaction chamber having a first attachment wall and a second attachment wall extending between the first surface and the second surface, the first attachment wall and the second attachment wall being opposite and spaced apart from each other,
a fluid supply inlet configured to introduce a fluid stream into the interaction chamber,
an outlet nozzle downstream of the fluid supply inlet, wherein the fluid stream exits the interaction chamber through the outlet nozzle,
a first feedback channel coupled to the first attachment wall and a second feedback channel coupled to the second attachment wall, the first feedback channel and second feedback channel being in fluid communication with the interaction chamber, each of the first feedback channel and second feedback channel having a first end and a second end opposite and spaced apart from the first end, wherein the first end is adjacent the outlet nozzle and the second end is adjacent the fluid supply inlet, wherein the first attachment wall and second attachment wall of the interaction chamber are configured to allow fluid from the fluid stream to flow into the first end of the first feedback channel and the first end of the second feedback channel and to cause the fluid stream to sweep between the first attachment wall and second attachment wall of the interaction chamber, and
at least one secondary feedback channel, each secondary feedback channel having a first end and a second end opposite and spaced apart from the first end of the secondary feedback channel, wherein the first end of the secondary feedback channel is in fluid communication with either the interaction chamber, the first feedback channel, or the second feedback channel, and a second end of the secondary feedback channel is in fluid communication with the outlet nozzle, wherein the first end of the secondary feedback channel is positioned to allow fluid from the fluid stream to flow into the first end of the secondary feedback channel and out of the second end of the secondary feedback channel and to interact with the fluid stream in the outlet nozzle,
wherein the sweeping of the fluid stream between the first attachment wall and second attachment wall of the interaction chamber causes the fluid stream exiting the outlet nozzle to sweep; and
wherein the fluid exiting the second end of the at least one secondary feedback channel interacts with the sweeping fluid stream exiting the outlet nozzle such that the fluid stream exiting the outlet nozzle sweeps three-dimensionally.

15. The device of claim 14, wherein the second end of the secondary feedback channel is defined by a side wall of the outlet nozzle, wherein the side wall extends between the first surface and second surface of the inner channel.

16. The device of claim 15, wherein the device comprises a first secondary feedback channel and a second secondary feedback channel, wherein the second end of the first secondary feedback channel is defined by a first side wall of the outlet nozzle, and the second end of the second secondary feedback channel is defined by a second side wall of the outlet nozzle, the first side wall and the second side wall being opposite and spaced apart from each other.

17. The device of claim 14, wherein the second end of the secondary feedback channel is defined by either the first surface or second surface of the inner channel.

18. The device of claim 14, wherein the device comprises a first secondary feedback channel and a second secondary feedback channel, wherein the second end of the first secondary feedback channel is defined by a portion of the first surface of the inner channel defining the outlet nozzle, and the second end of the second secondary feedback channel is defined by a portion of the second surface of the inner channel defining the outlet nozzle.

19-34. (canceled)
